(19) United States
(12) Patent Application Publication
(10) Pub. No.: US 2005/0055241 A1
(43) Pub. Date: Mar. 10, 2005

(54) Apparatus, system and method for clinical documentation and data management

(76) Inventor: Stephen P. Horstmann, West Chester, PA (US)

Correspondence Address: HARDING, EARLEY, FOLLMER & FRAILEY;86 THE COMMONS AT VALLEY FORGE EAST, 1288 VALLEY FORGE ROAD, P.O. BOX 750, VALLEY FORGE, PA, 19482, US

(21) Appl. No.: 10/658,118

(22) Filed: Sep. 9, 2003

(51) Int. Cl. G06F 17/60

(52) U.S. Cl. 705/2

(57) ABSTRACT

A system, method and apparatus for management of clinical studies to facilitate the tracking of the studies by personnel involved in the study, such as managers, coordinators, and vendors, wherever they are located, as well as placing orders, and receiving financial information, the invention being suitable for managing clinical trial documentation in connection with the pharmaceutical industry, and for facilitating communications and delivery of clinical data and documentation between clients who initiate a clinical study and a vendor who may, for example, provide data capture, data packaging, and submitting the study documentation to the appropriate authority, such as, for example, the FDA or WHO.

### BACKGROUND OF THE INVENTION

1. Field of the Invention

This invention relates to an apparatus, system, and method for producing documentation and managing clinical trial data collection.

2. Brief Description of the Related Art.

A clinical trial, in its most general form, is a research study which is designed to answer specific questions about whether new drugs or treatments, including vaccines, new therapies, new ways of using known treatments, and medical devices are both safe and effective on people. Clinical trials are conducted to determine whether a proposed new treatment method, drug, medical procedure, device, or process is able to work to treat safely and rapidly the ailment at issue for an individual. The clinical trial is generally a lengthy process (3 or more years) and relies upon human participants who are drawn to the new treatment in view of its prospects, and thereby permitted to gain access to new research treatments before they are widely available, at the same time helping others, namely scientists and researchers, by contributing to the body of medical research which may enable others in the future to receive the drug or treatment as a routine remedy. Generally, researchers who wish to investigate the prospect of a new treatment or drug devise ideas for clinical trials. Often, researchers will test the new treatment or drug on an animal in a laboratory, attempting to mimic the system or a fact studied in an environment analogous to the proposed human environment for which the treatment or drug may be ultimately designed. Many ideas are weeded out during the laboratory studies, which precede the human studies. This leaves the researcher with the most promising treatments, which are those having the most beneficial results. From here, these treatments are then adapted to clinical trials. A clinical trial is useful not only for determining a greater abundance of information which is gained about a new drug or treatment, but also for the associated risks and how well the drug or treatment works or does not work to remedy the associated condition for which it was designed. In addition, other data is often collected and researchers may look at additional information gained in the study leading to yet further treatment or drug discoveries and applications.

There are many sponsors of clinical trials. Often universities will conduct clinical trials or studies in connection with their own medical research, or for an outside company, such as a pharmaceutical company, a contract research organization (CRO) or a government institution. Other sponsors or contributors to clinical trials or their funding may also include organizations or individuals such as physicians, medical institutions, foundations, voluntary groups, pharmaceutical companies, as well as government agencies such as the National Institutes of Health, (NIH), the Department of Defense (DOD) and the Department of Veteran's Affairs (VA). The clinical trials must be conducted in a facility which can accommodate the participants of the trials. Locations often include hospitals, universities, doctors' offices, clinics, or other sites where the physicians, or investigative staff may be located. In many cases, clinical trials are conducted in multiple locations. This also even may include multiple locations in a region or multiple locations throughout the world. In some cases this is done to assess the treatment or method's effect in different geographic, genetic, or cultural groups, while in others, the participants meeting the requirements for a study may be located in various parts of the country or of the world, making clinical research at one location impossible.

Each clinical trial is based on a protocol which is, in effect, a study plan designed to safeguard the health of the participants, while at the same time investigating the drug or treatment to provide answers to specific research questions. The protocol is a specification and description of testing procedures, qualifications for participants in a given trial, a schedule of the tests to be administered to the participants, the particular medications, and their dosages to be given to the participants, as well as the duration of the study. The participants in a clinical study follow the protocol and are assessed on a regular basis for any positive or deleterious effects of the treatment or drug, as well as to enable researchers to investigate and evaluate the effectiveness or success of a given treatment. The evaluation of the participants often involves maintaining and managing the categories or groups of participants according to a participant's characteristics, perhaps prior symptoms, and even the type of treatment the participant is receiving, among other things to be studied. For example, certain participants in a given study may receive a placebo, which is inactive and merely designed as a control against which to evaluate and compare the results among those who are receiving the new drug or treatment, or standard treatment.

Clinical trials are basically divided into four categories, including treatment trials, prevention trials, screening trials, and quality-of-life trials. New treatment, new combinations of drugs, new approaches to surgeries, new medical devices, or therapies, such as radiation therapy, are tested in treatment trials. Prevention trials are designed to look for better ways to prevent diseases among people who have never had the disease or to prevent the recurrence of a new disease, and may include the administration of medicine, vitamins, vaccines, minerals or lifestyle changes. Screening trials are associated with the detection of certain diseases or health conditions and attempt to investigate or evaluate the best or earliest way to detect them. Quality-of-life trials are associated with a chronic illness and lead to the exploration of ways to improve the comfort and quality of life for individuals affected by the illness.

Clinical trials are conducted in phases. Generally, there are four phases, phase I trials, phase II trials, phase III trials, and phase IV trials. A new drug or treatment is first investigated in a phase I trial with a small group of people, about 20-80, in order to evaluate safety, determine a safe dosage range, and identify side effects. The effectiveness of the drug and further evaluation of safety are studied with a larger group of people, about 100-300, in phase II trials. Phase III trials are conducted to study the drug or treatment among a larger group of people, 1000-3000, in order to confirm the effectiveness of the treatment or drug, monitor the side effects, compare the new treatment or drug to the standard treatment (if there is one) and collect information to allow the drug or treatment to be used safely.

Throughout a clinical trial, the information must be carefully obtained and stored. Information is obtained for each patient in accordance with the protocol. The protocol is developed through the evaluation of the studies to be undertaken, the participants involved, and other factors required in order to determine the effectiveness, safety, dosage and other aspects of the drug or treatment to be evaluated.

Data and information relating to a protocol and the clinical trial studies are collected, stored and analyzed, and are voluminous. Often, much paperwork is involved. Data can be stored on digital or magnetic media, including computer disc. There has also been computer software, which attempts to assist in the data collection and storage.

Often a clinical study manager employs the services of vendors who package the data for filing with the appropriate government or regulatory body. Since there is an abundance of information to maintain, and the information may originate from several locations throughout the world, collecting and packaging the clinical data and other information may be quite onerous.

Often, there are multiple vendors involved in the management of clinical trial studies. A clinical trial study may involve a number of tasks, such as, for example, protocol design, data collection, data packaging and data storage, and consequently, more than one vendor may have a role in each specific part of a clinical trial study management task. Coordination of the study tasks often may involve sundry meetings, telephone conferences, as well as exchanges of documents. In many instances, it is time consuming to determine which individual, group, or vendor needs to know about a particular task or document. There is the danger of leaving someone out, and hence a risk that an individual who needs to be aware of certain information is not kept informed. On the contrary, if an overabundance of information or documentation is sent to individuals or vendors who do not require it, it is time consuming and costly for them to determine it is not relevant to their particular role in the clinical trial study. As a result, clinical trial study documentation often is generated through a series of meetings or other communications involving vendors who need to have the information.

A need exists to carry out clinical trial studies, including the document design, and data collection and packaging, in a manner where a piece of the design, such as a task, is maintained as it relates to the entire timeline of the clinical trial study.

### SUMMARY OF THE INVENTION

The present invention provides a system, method and apparatus for managing clinical studies to facilitate the tracking of the studies by personnel involved in the study, such as managers and coordinators, wherever they are located, as well as placing orders, and receiving financial information. The invention is particularly suitable for managing clinical trial documentation in connection with the pharmaceutical industry. Clinical trial documentation comprises paper and electronic means for collecting data required to support a clinical trial. The invention facilitates communications efficiency and the production timelines for clinical trials documentation. The invention is designed to accelerate clinical trials, reduce time-to-market and increase economic efficiency for the users, such as clinical trial organizers and drug manufacturers. The invention facilitates communications and delivery of clinical data and documentation between clients who initiate a clinical study and a vendor or vendors who may, for example, provide long-term data storage, disaster recovery, data capture, data packaging and submission of the study documentation to the appropriate authorities, such as, for example, the FDA or WHO.

The apparatus has a data storage device, and a processor associated with the data storage device, which, for example, may comprise a computer. The data storage device and processor, preferably, may receive inputs from an input device, such as a keyboard, microphone, mouse or the like, and information may be viewed on a display or monitor. The apparatus, system and method provide for globally managing a clinical study and the information gathered and generated, as well as the process itself. The exchange of information is secured to minimize risks of unauthorized users obtaining the information. The invention provides a timeline management system with notification to designated users, who may be in different locations, in order to facilitate the management of a clinical study so that the users may track the progress of a study by accessing the study information and documents through a communications link, such as the Internet. The invention facilitates the tracking of all shipments made in connection with a clinical study and facilitates the status of the shipments, including delivery confirmation to a designated site, so that the authorized users may ascertain the location of documents and other materials pertaining to the study.

The clinical study information is stored in the data storage device from which authorized users access the information, including the clinical data, through a communications linkage, for example, the internet. The data storage device is configured so that the users may view the information, no matter where they are located. The information may be displayed in a manner in which the user desires to view it. Access discrimination may be utilized to enable multiple levels of access to be granted to those accessing the information from the data storage device. The invention allows a user to centrally manage information and documentation relating to the design, production, fulfillment, data collection, and data packaging of a clinical study.

It is an object of the present invention to provide an apparatus, system and method for producing documentation and managing clinical trial data collection.

It is another object of the present invention to provide an apparatus, system and method for collecting information and managing clinical studies globally.

It is another object of the present invention to provide an apparatus, system and method for clinical study management which delivers notification to users through a focused communication.

It is another object of the present invention to provide readily viewable displays of information on real-time influenced time lines, which may also show when a key event has been completed or a time period signifying when a milestone has been reached.

It is another object of the present invention to provide financial accounting in the form of current and historical records for the clinical study being managed.

It is another object of the present invention to facilitate the management of the production status reporting.

It is another object of the present invention to facilitate the tracking and inventory of clinical trial documents which are produced during a study.

It is another object of the present invention to provide a novel method, system and apparatus for managing clinical trial study documentation and data which provides authorized users with the ability to collaborate on study documents and their design, and wherein the collaboration is maintained and integrated with the tracking and status of one or more additional tasks of the study management.

It is another object of the present invention to facilitate the coordination of a distributed global workplace by enabling users to collaborate, centralize clinical study documentation, view the progress and status of study designs, production, shipping and delivery information, as well as manage inventories and deliveries at one or more locations pertinent to the study.

### BRIEF DESCRIPTION OF THE DRAWING FIGURES

FIG. 1 is a screen display illustrating the invention showing an initial information screen or home screen.

FIG. 2 is a screen display illustrating the invention, and showing a project menu and a project task window, showing project status information.

FIG. 3 is a screen display illustrating the invention showing the tracking and logistics screen with a shipping information selection window.

FIG. 4 is a screen display further illustrating the tracking and logistics screen with shipping information being displayed.

FIG. 5 is a screen display illustrating the invention showing project file management.

FIG. 6 is a screen display illustrating the invention showing accounting information selections.

FIG. 7 is a screen display illustrating the invention showing project management status information.

FIG. 8 is a screen display illustrating the invention showing project management status information.

FIG. 9 is a schematic diagram further illustrating the invention.

FIG. 10 is a schematic diagram further illustrating the invention.

FIG. 11 is a schematic diagram illustrating hardware in connection with the present invention.

### DETAILED DESCRIPTION OF THE PREFERRED EMBODIMENTS

The present invention provides a system, method and apparatus for management of clinical studies to facilitate the tracking of the studies by personnel involved in the study, such as managers and coordinators, wherever they are located, as well as placing orders, and receiving financial information. The present invention is described herein in connection with a variety of aspects of clinical studies, which may include formulating a protocol for a study, collecting, storing, retrieving and exchanging data, as well as managing and tracking inventories at multiple sites which are part of the clinical study.

The apparatus of the present invention has a processor and a data storage device which is operable in conjunction with the processor. The data storage device and processor are also operable in conjunction with a user input device which enables the user to input information and make selections. Preferably, the apparatus has a viewing device, such as a printer or monitor on which to view the processed information. The processor may be provided in the form of a computer, and the storage device may be provided along with the processor. A user input device, such as, for example, a mouse or keyboard may be used to facilitate the user's interaction with the apparatus. Alternately, the user input device may comprise a touch panel or touch screen monitor, or other suitable means for permitting the user to make selections.

Software is preferably implemented to manage the processor to facilitate the operations involved in the management of the data. For example, data may be stored, retrieved, exchanged, or displayed. As the clinical study progresses, information from the study is collected, including management information as to inventory, location, shipping, production and other documents or information generated by or in connection with the clinical study.

In a preferred embodiment, the invention provides a system for managing projects involving clinical trial documentation, and has particular applicability to the pharmaceutical industry. The system centralizes information through a data storage device which stores information, including the clinical trial documentation. In many instances, clinical trials involve subjects, participants and managers in remote locations, including in different parts of the world. The system data storage device stores data relating to the clinical study. A communications link is provided to facilitate access to the data storage device as well as the information contained therein. Preferably, the information may be input and retrieved directly on a computer or through a communications link, such as the Internet, where a remote computer may be used by which the user may participate in the management of the clinical study, as if the user were at any location.

The apparatus, method and system preferably comprises a communications center for facilitating communications between client users who are involved in the study, as well as others who are involved, such as, for example, the vendor who is to package the study data. These users may be managers or other personnel carrying out tasks to support the study. The communications center preferably comprises a project email center. The project email center preferably is associated with a particular project or study. The project email center may serve a user team and partner, such as a vendor. There may be multiple email project centers in order to streamline communications with those team members, managers, and/or vendors who are to be kept informed as to events associated with a particular project or study. The project email center provides a way to maintain communications involved in a study and to facilitate providing the communications to users, whether a client user or vendor user, to improve coordination of the study information.

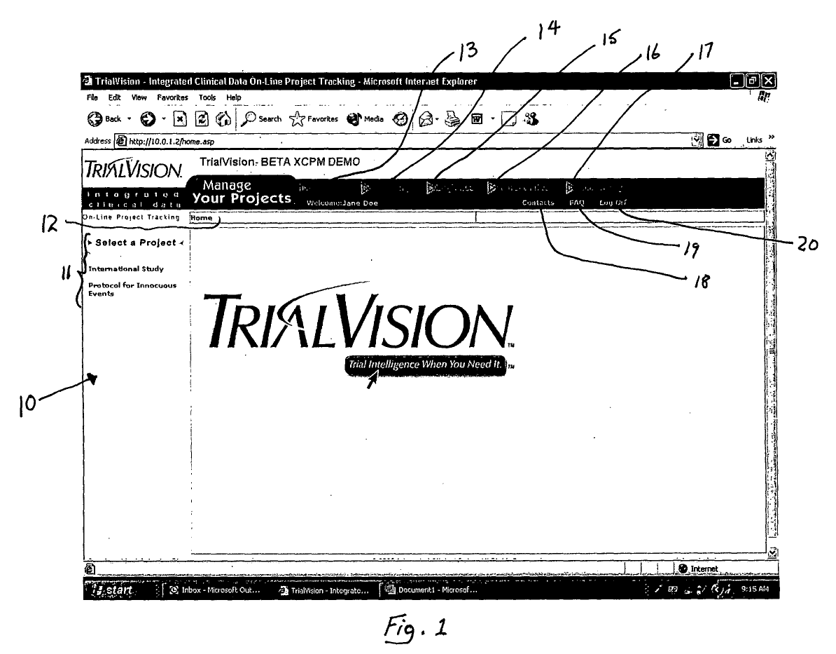

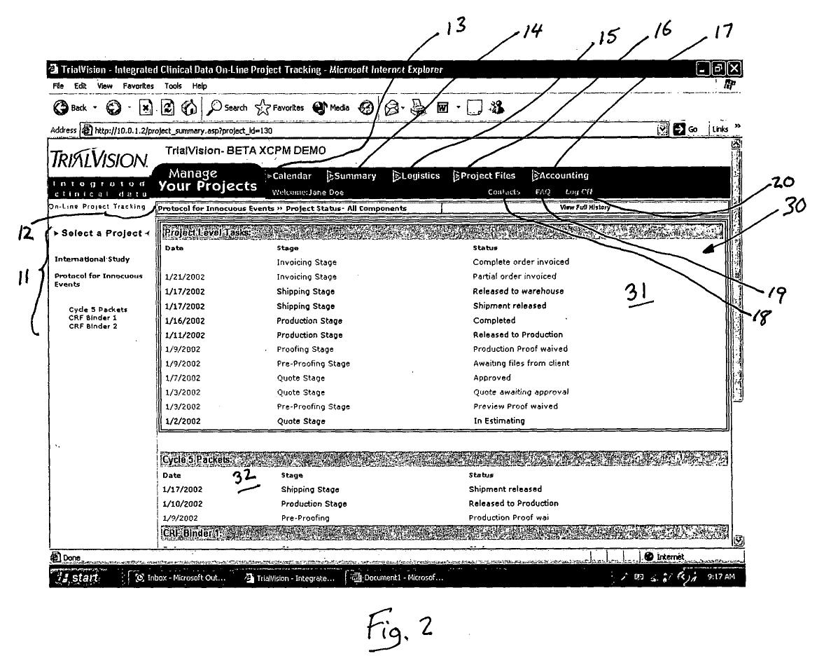

Referring to FIG. 1, a screen display 10 illustrating an example of a project menu 11, is illustrated. The user is presented with a selection of projects appearing in the project menu 11. In the example illustrated, projects “International Study” and “Protocol For Innocuous Events” are listed. The title bar 12 identifies “home” on the start screen 10. As shown in FIG. 2, the project “Protocol For Innocuous Events” is selected, and appears in a title bar 12 identifying the selected project name. Project level tasks information is displayed on the screen display 20 to provide data for the tasks, which in this example include the date, the stage of the project, and the status (i.e., whether completed or at some other stage, such as in estimating). The project “Protocol For Innocuous Events”, in this example, has a first component and a second component. The first project component is listed and illustrates information which may be displayed, such as the date and the stage (such as, for example, pre-proofing stage), as well as the status (such as, for example, preview proof approved or awaiting approval). The first project component here is “Cycle 5 Packet”. A second project component is listed and is illustrated showing a date, stage, and status for a task of a project. The second project “CRF Binder 1”, is also listed, as is a third component, “CRF Binder 2”. In this example, the project illustrated, “Protocol For Innocuous Events”, is component based and comprises one or more components, here, for example, a first component, a second component and third component.

Alternately, or in conjunction with the components of the study, the projects may be comprised of work orders. A work order may itself include one or more components, and each component, as illustrated in FIG. 2, may comprise tasks for that part of the project. A work order may be used for management of projects where a specified time for completion is required to complete one or more tasks, which may be components, within a particular time frame. Component tasks preferably are maintained through information which includes stage information and status information, as well as the time of the status or date. The stage information provides information about a particular task which is to be carried out in connection with a project. Referring to FIG. 2, “Project Level Tasks” is illustrated with the first two stages being a “Quote Stage” and a “Pre-Proofing” stage, where the status information, respectively, is “In Estimating” and “Preview Proof Waived”. The project level tasks are also displayed to show the work order or component breakdown, as here, for example, in the project “Protocol For Innocuous Events”.

A user may view these projects if that user is identifiable by the system. Preferably, discrimination means is provided to identify each user with unique login data so that the user may access information, including project information, which is pertinent to that user, or which a manager permits that user to see. It is recognized that, at times, it may be appropriate for some users to have access to all of the information, and other users only some of the information. One or more authorized users may view the projects. Other users who have not been given authorization may be excluded from one or more of the projects, but may be given access to other projects. Authorized users view the information stored in the data storage device, and preferably, through a communications linkage, which may, for example, comprise an Internet connection and Web browser software, and are permitted to view the same information within the same time frame.

Preferably, the buttons shown on the screen display 10, which include a calendar button 13, summary button 14, logistics tracking button 15, project files button 16, and accounting button 17, are not highlighted, and remain inactive until a project is selected from the project selection menu by an authorized user, or in the case of a new project, until that project is initialized. Also shown is a contacts button 18, a FAQ button 19, and a log off button 20. Preferably, the contacts button 18, when selected, provides contact information for users and those involved in the study. For example, it is preferred that the contacts button retrieve the names of individuals having a role in the study, and their respective contact information, including email address (which may be linked); telephone number, mailing address, and any other pertinent information. For example, the client side may include contacts for the project managers, and the vendor side may include contact information for the administrator or project coordinators, such as a sales representative or customer service person, as well as the webmaster and designers. The contacts enable users to communicate readily with the appropriate person. The contact information can be provided to vary with the needs of a particular study.

Referring to FIG. 2, a project called “Protocol For Innocuous Events” is selected from the project selection menu 11, and provides the screen display 30 illustrated in FIG. 2. “Cycle 5 Packets” is illustrated as a project component or work order, and as shown on the screen display 30, appears below the project level tasks window 31. Project level tasks appear for the project “Protocol For Innocuous Events” selected from the project selection menu 11. Preferably, chronology information, shown, for example, comprising associated dates for the project level tasks, are included. As shown, the date of the status appears in the window 31.

A calendar means is provided for users view scheduled tasks, status goals, and progress of completed stages. Preferably the calendar means comprises a calendar is populated with the data associated with the stages for studies and projects. FIG. 2 illustrates the calendar selection button 13 which can be selected by a user with selection means. In this example, a user may select with a keyboard or mouse the calendar button 13 to display a calendar of stages for a corresponding project or study. When the calendar button 13 is selected, the processor retrieves the information associated with the selected project and a calendar window is opened for display, preferably as a separate window. The calendar window, although not shown, displays information regarding projects and studies, including a listing of dates and tasks, and may be provided in the form of a block calendar diagram with the stages listed in conjunction with their appropriate dates, a timeline, or other suitable calendar display. Graphical representations of timelines for a study are made available for project and commitment management. The timelines may be updated in real time to reflect information added to the data for a project.

A summary of the project level tasks is displayed in the screen display 30 shown in FIG. 2. The summary button 14 is provided to enable selection of the summary window, such as is illustrated in the screen display 30. The tasks may be further summarized and broken down to appear by components or work orders. The task breakdown portion 32 of the screen display 30 lists the project component of component “Cycle 5 Packets” for the project “Protocol For Innocuous Events”. In this example, the first component, and second component, “CRF Binder 1” are listed to provide the breakdown of the project tasks. Although not shown, a work order may also be listed and the stages for that work order identified in a similar manner. The work order stages may include components. The work order tasks may be further broken down in this manner when listed in the task breakdown portion 32 of the screen display 30.

Tracking means is provided to facilitate tracking of project materials, including documentation and other items which may be transported or shipped during a project or study. For example, study documentation being shipped from the vendor to the client can be readily accounted for, and its location ascertainable by the users. The tracking means facilitates logistics management by providing shipping information for a project. Preferably, users involved in a project may access the shipping information for display on a screen. As shown in FIGS. 1 and 2, a tracking button 15 is displayed on the screen 30.

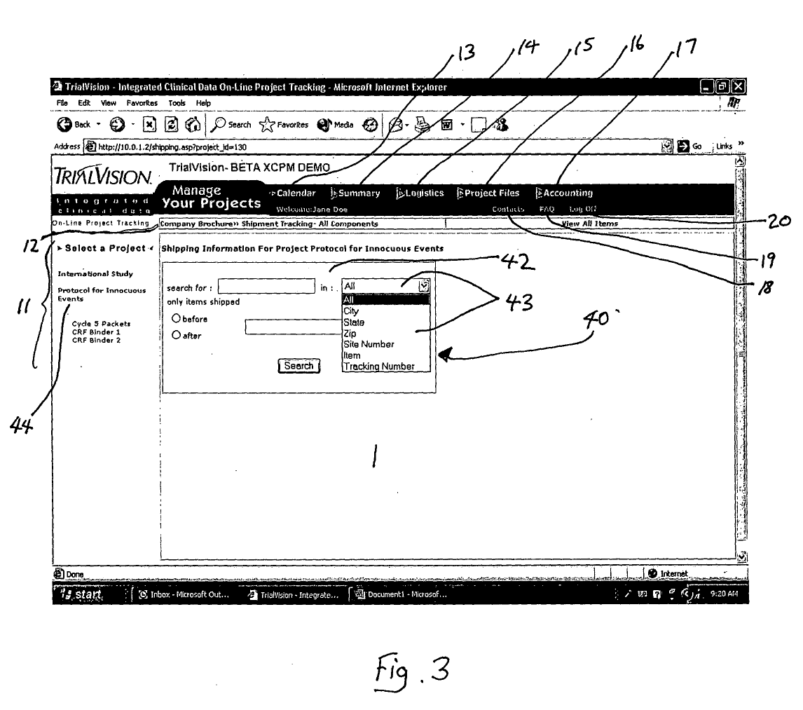

Referring to FIG. 3, a screen display 40 is illustrated as an example of the information provided when the logistics button 15 is selected. Shipping information about items pertaining to the project may be made available to the user. The user may search for a particular date by selecting from the search portion 42 of the screen display 40 a limitation for the search text from the drop down menu 43.

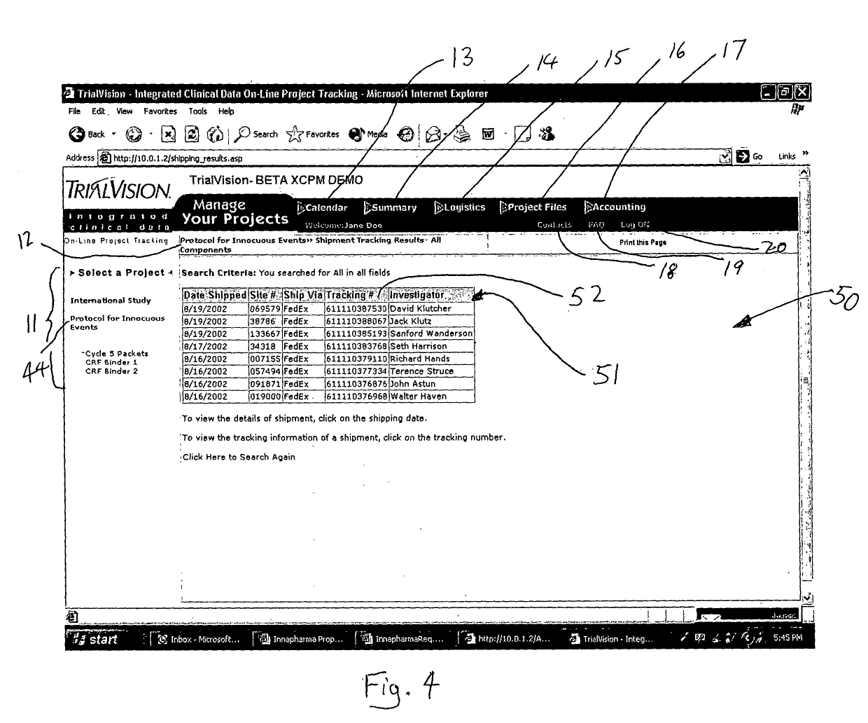

In FIG. 4, shipping information pertaining to all of the items shipped in connection with the project “Protocol For Innocuous Events” is displayed on a screen display 50. Project “Protocol For Innocuous Events” is designated as the active project by being prominently displayed here by highlighting or shading 44. The shipping information is preferably provided in a portion of the screen display, such as the shipping table 51, and preferably includes a tracking link 52 for each item on the shipping table which has been shipped. Preferably, the tracking link 52, when selected, links with the shipping carrier's tracking information data for facilitation of ascertaining the location of items shipped in connection with the study. This link may be through an Internet connection or other communications means which the shipping carrier makes available. A tracking or logistics button 15 is provided so that the user may select it in order to view shipping information, including information about the status of items and their location, whether in fact an item has been shipped, or whether an item is at a particular location, and the names of the shipping and receiving parties, as illustrated in the shipping table 51 of FIG. 4. Information relating to quotes, the release of shipments, package delivery, and signature may be tracked to be made available to a user. Issue tracking means is also provided to handle and maintain an account of historical data on each stage of the project.

Inventory management means is provided to facilitate the management of inventory throughout a clinical study. The inventory management means preferably comprises client inventory information which may be viewed and released for shipment to one or more designated sites. Preferably, secure electronic means for document delivery is employed to facilitate the transmission of clinical study documents to the authorized recipient users.

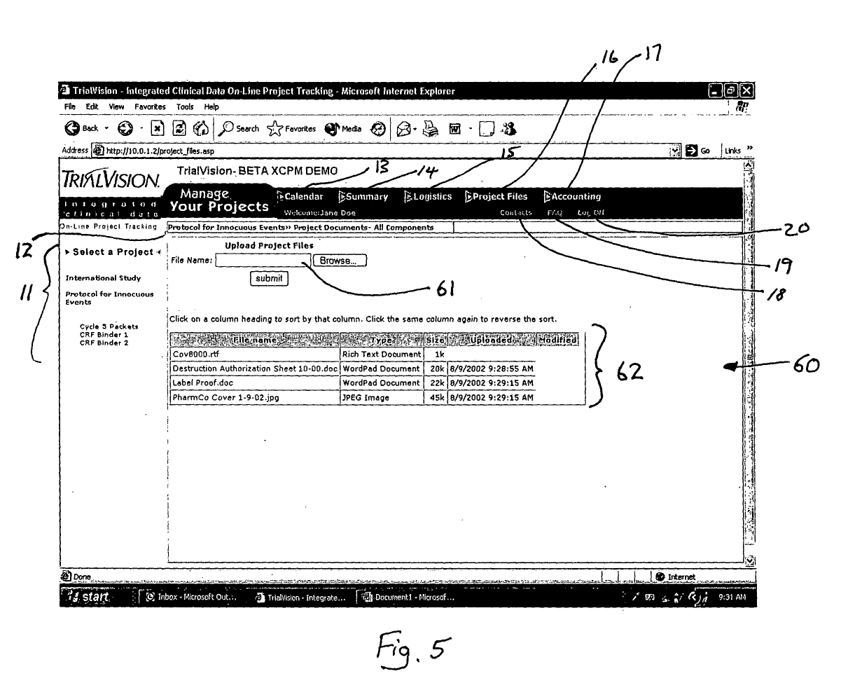

Project files are managed by the user and may be uploaded from a storage device, which may be a storage device other than the system's storage device. For example, a user who is authorized with the level of access to place information into the database of the system, may for example, upload files from the individual's own storage device. A project files button 16 is illustrated on the screen displays shown in FIGS. 1-8. In FIG. 5, a screen display 60 is illustrated and a file upload box 61 is provided, as the project files button 16 has been selected and a listing of files associated with the project is provided. Preferably, the files may be listed in a file table 62, or the user may browse a location, such as the user's own computer storage device, or hard drive, for files which the user may upload to the system. In this manner, the files may therefore be made available to other users, such as for example, the files listed in the table 62 shown on the screen display 60 of FIG. 5. Preferably, the files are stored in the data storage device of the apparatus and therefore remain available to all authorized users of the system. Project files preferably are stored with a version-controlled stamping means to identify the version of the document so that the document may be accessed at a later time to authorized users. The storage of the stamped versions on the data storage means enables the document to be accessed globally by authorized users.

Data management means is provided for facilitating the input of data in the form of an electronic data capture mechanism. The electronic data capture preferably provides a background file into which users enter data. The data is accepted and may be viewed in real time by appropriate user personnel such as for example, study managers. Alternately, data entry may be accomplished in any conventional manner, such as manually, electronic scanning, which may include transcription of data into the storage device from a written or printed sheet. The data capturing and data packaging preferably may be done, for example, by a vendor user for the client user.

The invention facilitates the design of clinical trial documentation, even where the designers are members of a global team, and are in geographically distinct locations. The document collaboration interface means provides for storage of information on the data storage device which authorized users may access. Users may annotate and discuss PDFs of designed documents using a secure workspace and standard reviewing tools or software. Study design collaboration is facilitated by the invention. The user may annotate a PDF in real time with other users, and annotations may be shown on the PDF in real time for each user making them. Preferably, the users may further communicate with each other through a chat dialog as the users are reviewing information, documents, or PDFs in real time. Reviewers and approvers are identified, and the status of the document is maintained to inform all concerned as to whether the document has been reviewed or approved

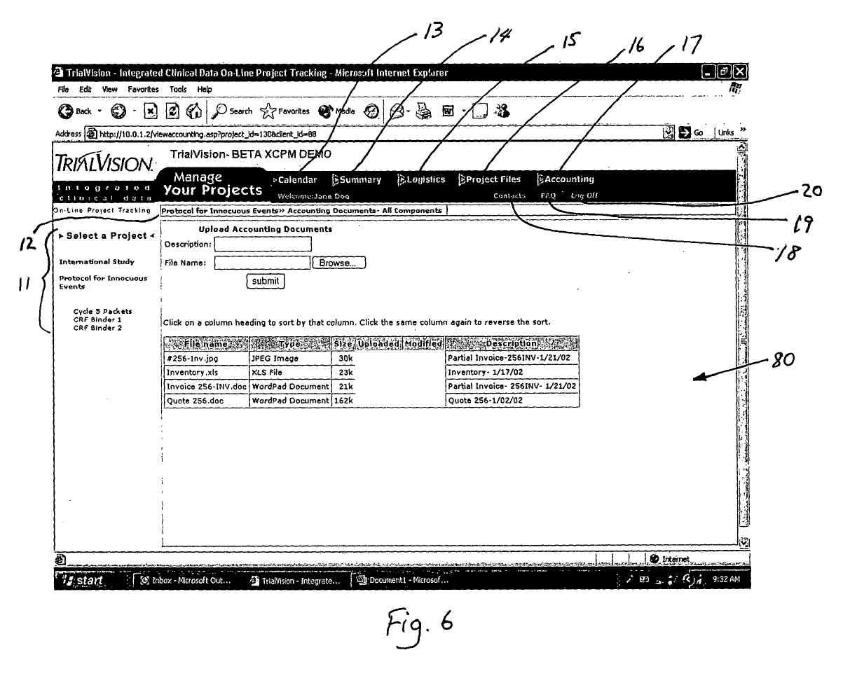

The accounting features are provided to maintain records for the accounting of documentation and other items of the projects for the study or project design. Accounting information preferably is stored in files maintained on the data storage device. The files may be uploaded from a user's own device to the data storage device of the system in a manner similar to that described herein in connection with the project files. FIG. 6 shows a screen display 80 of an accounting menu screen. The title bar 12 indicates that the information for the accounting documents is for all of the components (in this example, the first component and the second component) for the project “Protocol For Innocuous Events”. Financial tracking means is provided for facilitating access to information about quote activity, invoice data and electronics funds transfer records. The financial tracking means preferably may be controlled to permit certain users to access the financial information. Accounting information is stored in the data storage device, and preferably includes estimates, quotes, invoices, records of electronic find transfers, through uploading the information from the server device.

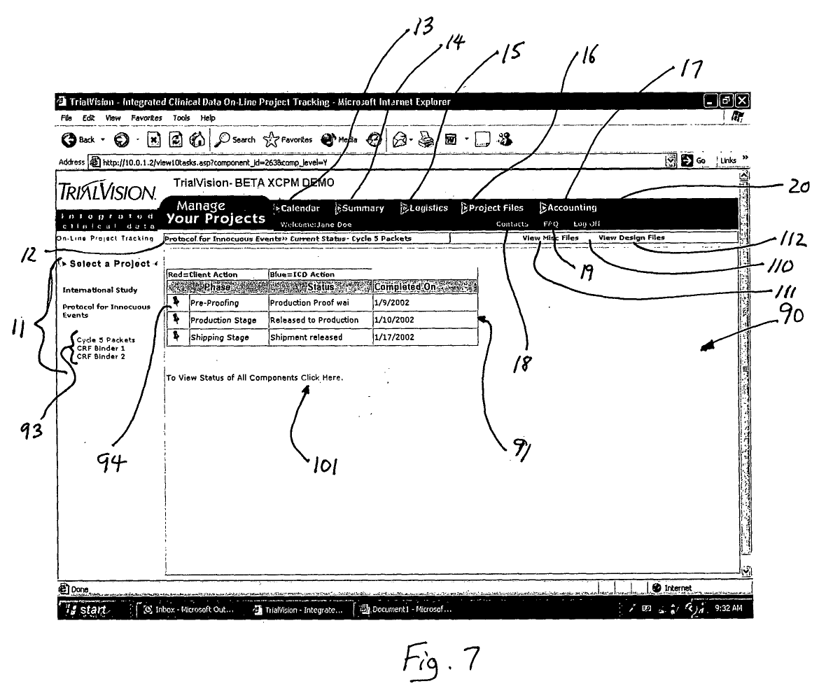

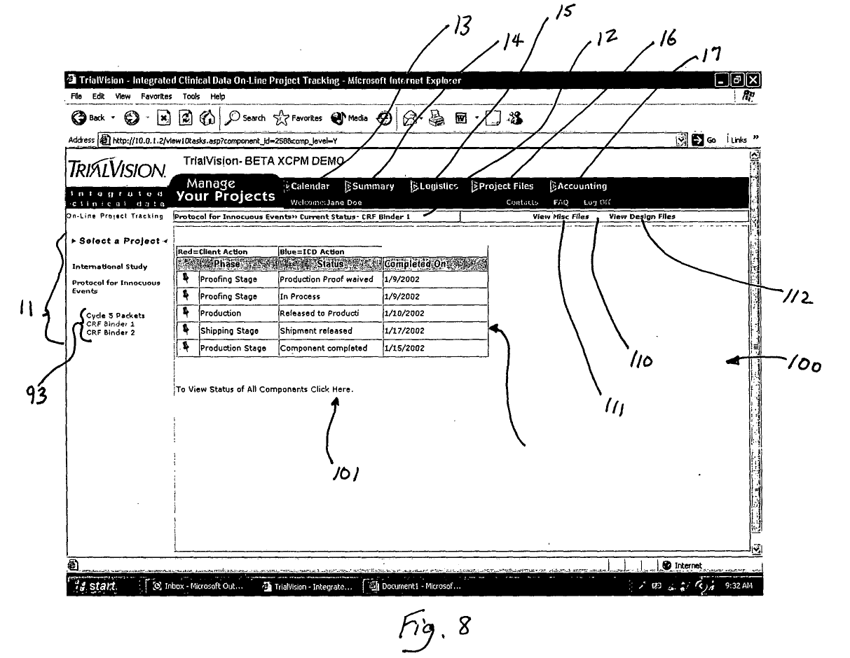

FIG. 7 shows a screen display 90 having a status information area 91 where the phase of the project, here “Protocol For Innocuous Events”, is shown for tasks of the first component, “Cycle 5 Packet”. The first component is indicated in the title bar 81 and is highlighted in the project selection menu 11. Indicator means is provided to illustrate graphically the action required for the task or phase (if not completed) or who completed the task or phase (if completed). The indicator means is shown preferably comprising indicia which corresponds with the acting party. In FIGS. 7 and 8, there is a client and vendor (ICD) referred to. The indicia in this illustration is color corresponding, red for client action and blue for vendor action.

FIG. 8 shows a screen display 100 for the current status information for the second component, “CRF Binder 1”. The second component is identified in the title bar 12 and also appears in the sub menu 93 of the project selection menu 11. Referring again to FIG. 2, there is illustrated the current status information for all components of the project “Protocol For Innocuous Events”. Preferably, there is provided complete status selection indicia 101 on the screens 90 and 100 illustrating the component status so that a user may readily have displayed on the display means the complete status of the projects. In FIGS. 7 and 8, the option to view additional project files is presented in a selection bar or area 110. The selection area enables options for viewing project files, here, a miscellaneous files selection option 111 and a design file selection option 112.

A home screen is illustrated in FIG. 1, and preferably, requires a user's login information so that the user may access the information, and have the screen display 10 made available to the user so that the user can select the projects from the menu and participate in the management of the clinical study or design.

Although not illustrated, preferably, business continuity means for minimizing disruptions to the operation a “Business Continuity” tab may be provided for selection by a user. The business continuity tab, when selected, will allow the user of the system, such as, for example, a client, to archive (for long-term) all information related to a project as well as any data that they may require storage for retrieval at a later time. This long-term storage capability will allow the client to recover from business interruptions and will act as an easy access method for obtaining historical information as well as current information. Preferably, the business continuity means comprises storing the project information and data using technology neutral formats (TNF), such as, for example, document imaging and pdf storage, so that data recovery in the long term, which may for example be thirty years or more, is not constrained by changes to software which may be in use at that time.

The invention preferably provides an information archive means for archiving the study documentation and data. In a preferred embodiment, the data archive means facilitates the reactivation of past studies, but does not permit client users to change any of the data. The information archive means preferably provides a backup for study documentation. The information archive means may, for example, comprise a secondary data storage on which may be stored clinical trial study documentation and data. The secondary storage device may be accessed by authorized users when reference to archived data becomes necessary.

In accordance with the invention, the data storage preferably includes means for formatting the patient information to comply with the EDI rule, and mandates in accordance with the Health Insurance Portability and Accountability Act (HIPAA).

Document collaboration means is provided for facilitating the collaboration on documents by a plurality of authorized users. Clinical trial study documents may be reviewed, approved and annotated by users, with user comment indicia being visible along with the identity of the user. The document collaboration means preferably comprises software which is operated on a computer, such as the processor or computer, and the user's comments or other indicia stored in the data storage device. The document collaboration means preferably stores information, such as, for example, revisions made to a document by a user, that a particular user has or has not yet reviewed a document, that a particular user has requested comments on a document by another user, that one or more users have completed the document, that a document has been completed.

Document collaboration means further facilitates real-time, or nearly real-time, collaboration by users. One or more users may review, provide comments on, or annotate a document, and the user's changes or additions may appear on a display to others who have also selected to view the same document. The user making comments or changes to a document preferably is identifiable to the other users, and the comments or changes, when made to the document may be associated with that user to identify the author. Similarly, other user's who likewise comment or change the document preferably also may be identified. The document collaboration means is useful for collaboration on any of the documents involved in the clinical trial study, some of which may, for example, include protocols, CRF design, Database annotation of the CRF design, and the like.

Document collaboration means integrates with the tracking means to facilitate the management of the study documentation. Users may create a document, annotate and review it, and then complete the document, when, for example, each user who was required or requested to comment on it has done so. The document collaboration means maintains document status information. The tracking means tracks the study documentation, and may be initialized for a document which is or has been generated, annotated or reviewed in connection with the document collaboration means.

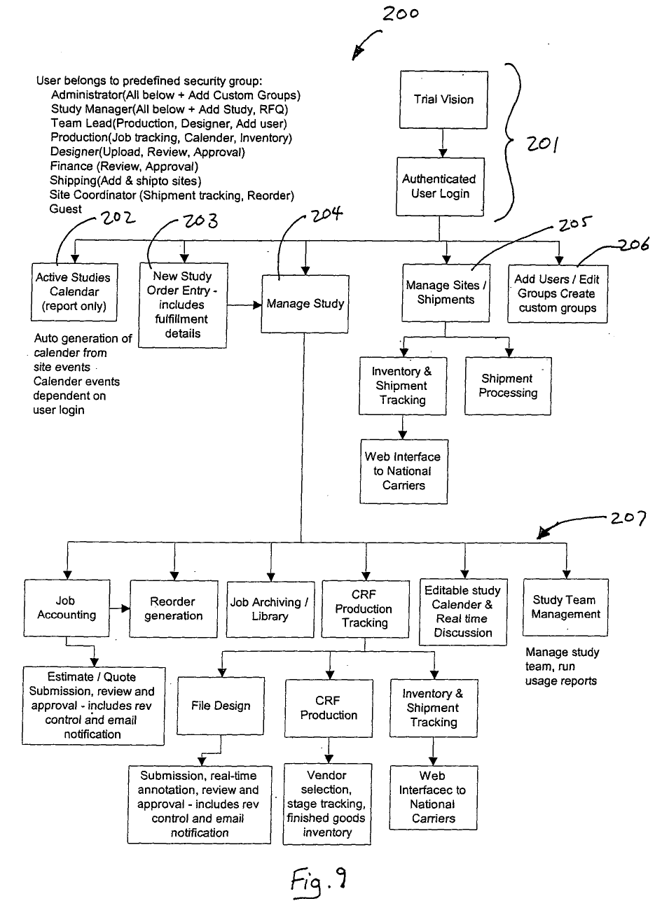

The document collaboration means and the tracking means facilitate the generation of documents, such as, for example, a design protocol for a clinical trial study. The design protocol may be viewed and worked on by the designers of the client as well as a vendor providing clinical study management services, such as, for example, data packaging, study documentation design, and other services relating to the clinical trial study documentation and data. The design protocol may be tracked as it is being developed so that the progress may be ascertained by authorized users who may access the protocol, and authorized users may contribute to or comment on the design. Although not shown, a design tab or button, similar to the logistics button 15, may be provided on the screen display so that authorized users may call a protocol for display on the screen, design or work on a protocol, or create a new protocol. Preferably, the document collaboration means provides real-time capability so that collaborations may be done by one or more individuals, who preferably review the same document, at the same time, and are able to see the comments, suggestions or changes of the other collaborating individuals. In addition, the document collaboration means may track and maintain the form of the document with each additional change, thereby providing a version history which may be accessed to show the document in the form it existed at any point prior in time. The document collaboration means provides a version controlled status, and enables archiving each iteration. FIG. 9 is a schematic diagram 200 illustrating the functions which may be available for a client user. The user inputs log-in information 201 which is checked against corresponding log-in information of the data storage device. Once the log-in data is verified, then depending on the user's access level which correlates with the user log-in information, the user may participate in one or more of the project management tasks which are listed, 202, 203, 204, 205, and 206. Where a user has selected the option to manage the studies, the user may manage study tasks, such as, for example, those tasks listed in the study task management section 207.

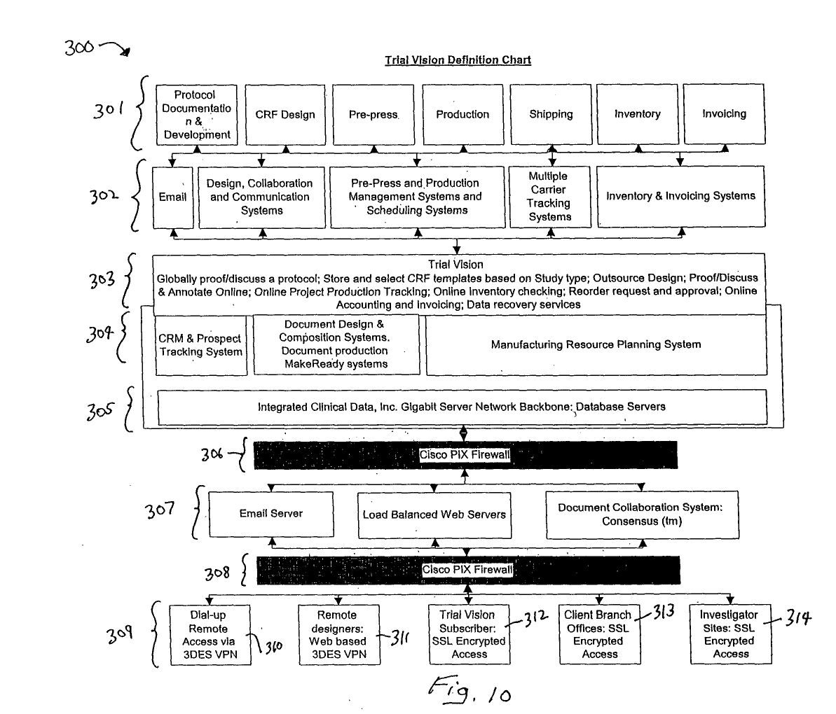

FIG. 10 is a diagram 300 illustrating the integration of management tasks which may be utilized in carrying out clinical trial studies. Project management tasks which are generally managed by a study coordinator are listed in area 301 of the diagram 300. Area 302 of the diagram 300 illustrates generic definition of the software tools and manual efforts required to deliver information for project management requirements. Area 303 of the diagram 300 illustrates the functions of the management system in conjunction with the integration with the software tools and manual efforts represented in area 302. Area 304 of the diagram 300 illustrates representative supporting technologies for communication (such as for example commercially available software programs, Goldmine® and Microsoft Outlook®), as well as document composition and collaboration (such as, for example, forms design software, and Acrobat 5.0®), production tracking software (such as, for example, MRP system: JobBOSS®).

Area 305 illustrates the network hardware backbone of gigabit SQL server, and preferably, the server where the data storage device is maintained. Area 306 illustrates a Cisco PIX firewall between data generation systems represented by areas 301, 302, 303, 304 and 305 and data presentation systems 307 and 309. Area 307 represents data presentation hardware, such as, for example, web servers and email servers that will host the project management system tasks interface (such as those represented by area 303) and allow the communication stream to be managed. Area 308 illustrates a Cisco PIX firewall between data presentation systems and the completely untrusted Internet. Area 309 illustrates a depiction of possible communications links or connection types: shown, left to right, for example, for an external production manager/employee with a dial-up VPN connection using 3DES (highest level) security, 310; an external designer with a dial-up or web-based VPN connection using 3DES (highest level) security, 311; an end user of the project management system (TrialVision) illustrated in area 303 using the Internet to log-in to the site using SSL level of encryption and security 312; a client or integrated branch office user using the Internet to log-in to the site using SSL encryption and security 313; and a peripheral end user with very limited access also using the web to connect and login—who also has to use the SSL security level 314.

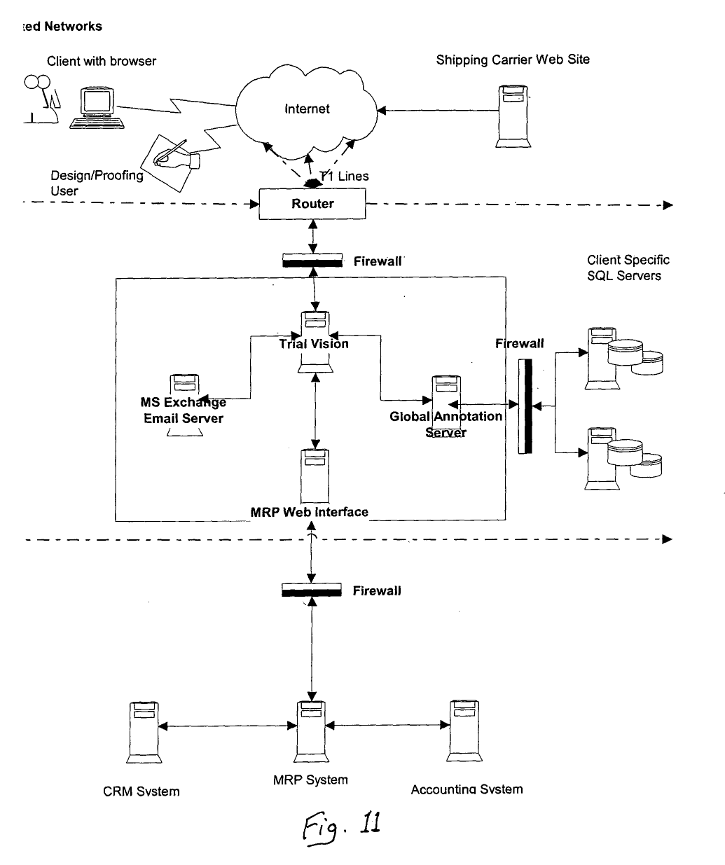

FIG. 11 is a schematic diagram for the network architecture illustrating the hardware connectivity and the security.

1. An apparatus for managing clinical studies to facilitate the tracking of the studies by personnel involved in the study, such as managers and coordinators, wherever they are located, as well as placing orders, and receiving financial information, comprising processor means for processing information, data storage means for storing data which is associated with the processor means, software for providing instructions to control the processor means, and a communications link for permitting from a location remote from the data storage means one or the other or both of access to information stored in the data storage means and retrieval of information stored on the data storage means, wherein the apparatus further comprises discrimination means for discriminating between users who have been assigned different levels of access.

2. A method for managing clinical studies to facilitate the tracking of the studies by personnel involved in the study, such as managers and coordinators, wherever they are located, as well as placing orders and receiving financial information, comprising the steps of processing with processor means for processing data stored in a data storage means for storing data which is associated with the processor means, and providing software for providing instructions to control the processor means, and exchanging information through a communications link and monitoring the status of one or more steps of a clinical study.

3. A system for managing clinical studies, comprising assigning a project management task as one of a component task and work order based task, tracking the status of the task through completion of the task, storing information about the task on a data storage device, providing access means for users to access the data stored on the data storage device to display information about the task.

4. A method for managing clinical trial studies, comprising the steps of: providing a processor, providing software to control the processor so that a plurality of users may collaborate on the same document, collaborating on a document including reviewing and annotating the document with the user's comments, tracking the status of the document by associating the collaboration status with the project status.

5. A method for managing clinical trial studies comprising the steps of storing information associated with clinical study documentation, providing a real-time status of clinical trial study documentation for a plurality of users accessing the information, where a change to the documentation by an authorized user is made available to one or more other authorized users, the method including maintaining the progress status for tasks relating to the clinical trial study documentation.
